(19) United States
(12) Patent Application Publication
(10) Pub. No.: US 2005/0023092 A1
(43) Pub. Date: Feb. 3, 2005

(54) Vehicle mount apparatus having asymmetrical variable stiffness

(76) Inventor: Jeong-Hoon Kim, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,237

(22) Filed: Dec. 30, 2003

(30) Foreign Application Priority Data
Jul. 30, 2003 (KR) 10-2003-0052715

(51) Int. Cl. F16F 9/53

(52) U.S. Cl. 188/267.2

(57) ABSTRACT

A vehicle mount apparatus has asymmetrical variable stiffness capabilities adapted to support an assembly body from both sides of a vehicle relative to a vehicle body. Thereby, minimizing vertical and horizontal vibrations generated by an engine in the assembly body and vibrations generated by the assembly body relative to the vehicle body during sudden starts and sudden stops and resulting in reducing trembling of the vehicle and improving ride characteristics of the vehicle.

### CROSS-REFERENCE TO RELATED APPLICATIONS

This application claims priority to Korean Application No. 10-2003-0052715, filed on Jul. 30, 2003, the disclosure of which is incorporated fully herein by reference.

### FIELD OF THE INVENTION

Generally, the present invention relates to an apparatus for mounting an engine and transmission to a vehicle. More particularly, the mount apparatus has an asymmetrical variable stiffness in relation to a running state of the vehicle.

### BACKGROUND OF THE INVENTION

Generally, a vehicle body is installed with an assembly integrally mounting an engine and a transmission (hereinafter referred to as assembly). Between the assembly and the vehicle body, it would be advantageous if there was an appropriate mount apparatus for preventing engine vibrations from being transmitted to the vehicle body. Therefore, relative vibrations between the assembly and the vehicle body, generated by changes of accelerated velocity occurring while a vehicle is running, can be properly restricted to reduce trembling of a vehicle and improve ride characteristics.

### SUMMARY OF THE INVENTION

The present invention provides a vehicle mount apparatus having asymmetrical variable stiffness. The apparatus is adapted to support an assembly body from both sides of a vehicle relative to a vehicle body and minimizes vertical and horizontal vibrations generated by an engine in the assembly body and vibrations generated by the assembly body relative to the vehicle body during sudden starts and sudden stops. Thereby, reducing trembling of the vehicle and improving ride characteristics.

In accordance with a preferred embodiment of the present invention, a vehicle mount apparatus having asymmetrical variable stiffness comprises a cushion member having two cushion block parts. The cushion block parts are each symmetrically arranged about a vertical line and positioned in the fore and aft direction relative to a vehicle body. Vehicle body brackets are secured at the vehicle body and contact inclines of the two cushion block parts. Assembly body brackets contact the inclines of the two cushion block parts and mount with an assembly body. A variable stiffness means is so mounted as to vary the stiffness of the two cushion block parts. A sensing means detects the changes of accelerated velocity of a vehicle. A controller receives a signal from the sensing means to control the variable stiffness means.

### BRIEF DESCRIPTION OF THE DRAWINGS

For fuller understanding of the nature and objects of the present invention, reference should be made to the following detailed description taken in conjunction with the accompanying drawings in which:

FIG. 1 is a structural drawing of a vehicle mount apparatus having an asymmetrical variable stiffness according to an embodiment of the present invention;

FIG. 2 is a constitutional drawing of the apparatus in FIG. 1 when an assembly comprising an engine and a transmission is vertically vibrated;

FIG. 3 is a constitutional drawing of the apparatus of FIG. 1 when a vehicle is operated during sudden starts and sudden stops; and

FIGS. 4 and 5 are schematic drawings for illustrating another embodiment of the present invention.

### DETAILED DESCRIPTION OF PREFERRED EMBODIMENTS

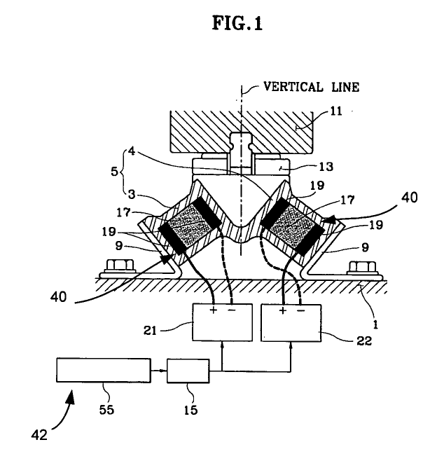

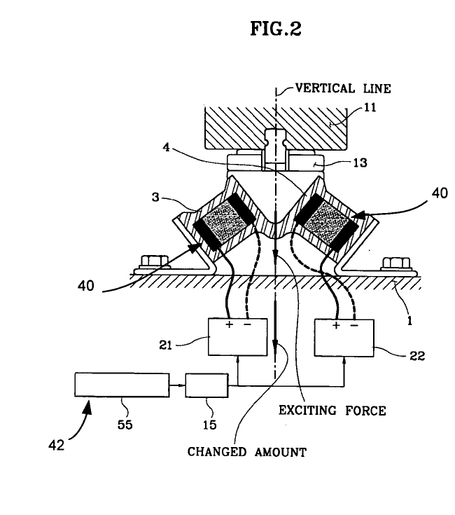

As shown in FIG. 1, the vehicle mount apparatus comprises: a cushion member 5 having two cushion block parts 3 and 4, each symmetrically arranged about a vertical line and positioned in the fore and aft direction relative to a vehicle body 1. The apparatus also includes vehicle body brackets 9 secured to the vehicle body and contacting inclines of the two cushion block parts 3 and 4. Assembly body brackets 13 each contact the inclines of the two cushion block parts 3 and 4 and are mounted thereon with an assembly body 11. A variable stiffness means 40 is mounted as to vary the stiffness of the two cushion block parts 3 and 4 and a sensing means for detecting the changes of accelerated velocity of a vehicle is also included. Furthermore, a controller 15, for receiving a signal from the sensing means to control the variable stiffness means is included.

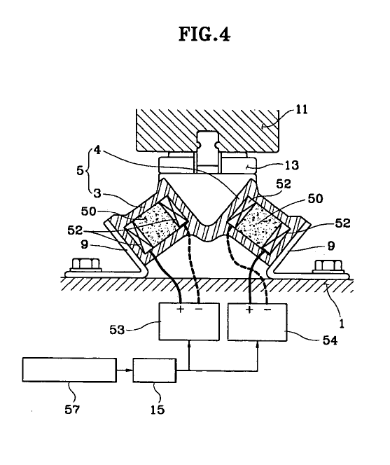

The variable stiffness means 40 includes Electro-Rheological (ER) fluid 17 filled in each cushion block parts 3 and 4. The variable stiffness means 40 also includes electrode plates 19, each installed to apply electromagnetic fields to the ER fluid 17, and power amplifiers 21 and 22 for applying electricity to the electrode plates 19. According to FIG. 4, preferably the variable stiffness means include Magneto-Rheological (MR) fluid 50 filled in each cushion block parts 3 and 4, electromagnets 52 each installed to apply electromagnetic fields to the MR fluid, and power amplifiers 53 and 54 for applying electricity to the electromagnets 52.

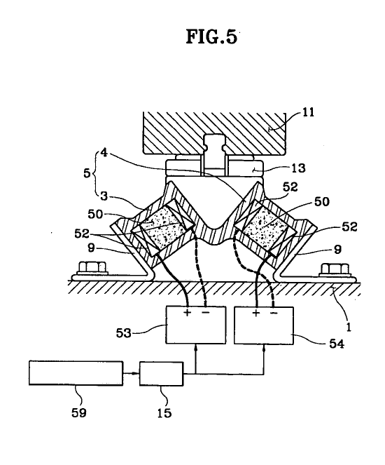

Preferably, the sensing means 44 is an accelerated velocity sensor 55 for sending an accelerated velocity of a vehicle as in the present embodiment. According to another embodiment preferably, as depicted in FIGS. 4 and 5 respectively, the sensing means 44 is a speed sensor 57 for sensing speed of a vehicle, or an engine revolution sensor 59 for measuring revolution of an engine.

Hereinafter, operation of an embodiment of the present invention will be described.

The controller 15 prompts the power amplifiers 21 and 22 to supply the same size of electricity to the electrode plates 19 installed at each cushion block part 3 and 4 if an accelerated velocity of a vehicle is not zero, the vehicle is not in a sudden start state or the vehicle is not in sudden stop state. The same size of electromagnetic fields formed by the electrode plates prompt the ER fluid 17 to exercise the same shearing force. As a result, the two cushion block parts 3 and 4 exercise the same stiffness.

When vertical exciting force generated by an engine is input, the exciting force exercises the same size component of force to each cushion block part 3 and 4, deforms the cushion block parts 3 and 4, and is consumed thereon, under the condition that the two cushion block parts 3 and 4 symmetrically arranged about a horizontal line provide the same stiffness. According to an embodiment of the present invention, it should be noted that the two cushion block parts 3 and 4 have the same stiffness with regard to vertical exciting force generated by the operation of an engine.

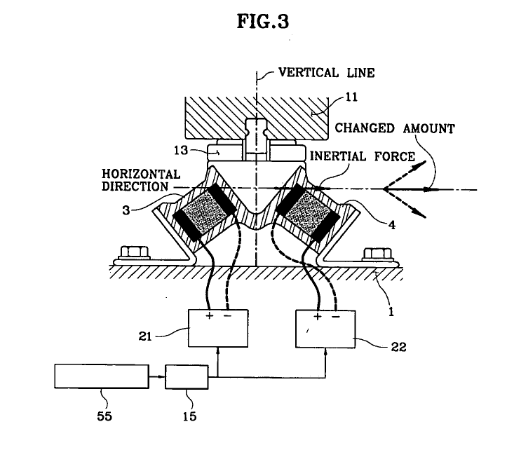

Next an explanation of the function during a sudden start or a sudden stop is detailed. FIG. 3 is referred to for explaining the sudden start as a representative example. When a left side of FIG. 3 is a front side of a vehicle, to greatly change an accelerated speed an inertial force of the assembly body 11 is enforced to the right side as shown in FIG. When it is detected by the accelerated velocity sensor 55 that a vehicle is suddenly started to greatly change the accelerated velocity, the controller 15 prompts the two cushion block parts 3 and 4 to have respectively different stiffness in response to the accelerated velocity. In other words, the controller 15 controls such that the electrode plate 19 arranged in the front side of the vehicle is provided with a larger electric power, whereby the cushion block part 3 arranged in the front side of the vehicle can exercise a larger stiffness. This is because a consideration is given to a fact that changes against tensile force are greater than changes against compression in the case of a cushion that is member made of rubber which is generally not changeable in stiffness.

If the two cushion block parts 3 and 4 are given the same stiffness with regard to an inertial force horizontally acting by the sudden start thus described, the inertial force is divided equally to the two cushion block parts 3 and 4. However, if the divided force is acted on the cushion block parts 3 and 4 as a tensile force, tensile changes of the cushion block parts 3 and 4 in the front of the vehicle relatively become greater than compressed changes of the cushion block parts 3 and 4 in the rear of the vehicle, such that summation of two changes of the two cushion block parts 3 and 4 do not face the horizontal direction, but face an upward side of the vehicle, thereby result in generation of vertical vibration relative to vehicle body of the assembly body.

As a result, the controller 15 drives the power amplifiers 21 and 22 in response to a signal input from the accelerated velocity sensor 55 to allow the power supplied the electrode plate 19 equipped at the cushion block part 3 positioned at the front of a vehicle to become lower than the power supplied to the electrode plate 19 arranged at the cushion block parts 3 and 4 positioned at the rear of the vehicle. Therefore, making the tensile changes and compressed changes of the two cushion block parts 3 and 4 equal, such that changes of the cushion member 5 can obtain only the horizontal element parallel to the inertial force generated by the sudden start of a vehicle.

In other words, vertical vibration of the assembly body 11 relative to the vehicle body 1 can be minimized during motion of constant accelerated velocity and sudden start of a vehicle, thereby improving the ride characteristics or comfort of occupants in the vehicle.

Furthermore, only the direction of the inertial force of an assembly body is reversed during a sudden stop while other operational principles are applied as the same principles thus described, such that the vertical vibration relative to the vehicle body 1 of the assembly body 11 can be also be prevented during a sudden stop to improve the ride of a vehicle.

As apparent from foregoing, there is an advantage in a vehicle mount apparatus having an asymmetrical variable stiffness thus described in that an assembly body is supported from both sides of a vehicle relative to a vehicle body to thereby prevent vertical and horizontal vibrations generated by an engine in the assembly body and vibrations generated by the assembly body relative to the vehicle body during sudden starts and sudden stops. Thereby, reducing trembling of the vehicle and improving ride characteristics for the occupants of a vehicle.

1. A vehicle mount apparatus having an asymmetrical variable stiffness, the apparatus comprising:
a cushion member having two cushion block parts each symmetrically arranged about a vertical line and positioned in the fore and aft direction relative to a vehicle body;
vehicle body brackets each secured at the vehicle body and contacting inclines of the two cushion block parts;
assembly body brackets each contacting the inclines of the two cushion block parts and mounted thereon with an assembly body;
variable stiffness means so mounted as to vary the stiffness of the two cushion block parts;
sensing means for detecting the changes of accelerated velocity of a vehicle; and
a controller for receiving a signal from the sensing means to control the variable stiffness means.

2. The apparatus as defined in claim 1, wherein the variable stiffness means comprises:
an Electro-Rheological (ER) fluid filled in each cushion block parts;
electrode plates each installed to apply electromagnetic fields to the ER fluid; and
power amplifiers for applying electricity to the electrode plates.

3. The apparatus as defined in claim 1, wherein the variable stiffness means comprises:
a Magneto-Rheological (MR) fluid filled in each cushion block parts;
electromagnets each installed to apply electromagnetic fields to the MR fluid; and
power amplifiers for applying electricity to the electromagnets.

4. The apparatus as defined in claim 1, wherein the sensing means is an accelerated velocity sensor for sensing an accelerated velocity of a vehicle.

5. The apparatus as defined in claim 1, wherein the sensing means is a speed sensor for sensing speed of a vehicle.

6. The apparatus as defined in claim 1, wherein the sensing means is an engine revolution sensor for measuring revolution of an engine.

7. A vehicle mount apparatus having an asymmetrical variable stiffness, comprising:
a sensor for detecting a change in velocity of a vehicle component;
a controller configured to receive output from said sensor; and
a variable stiffness apparatus configured and dimensioned to receive output from said controller and adjust a stiffness of said variable stiffness apparatus accordingly.

8. The apparatus of claim 7, wherein said variable stiffness apparatus is an engine or transmission mount.

9. The apparatus of claim 7, wherein said variable stiffness apparatus further comprises an electromagnet and magneto-rheological fluid.

10. The apparatus of claim 7, wherein said variable stiffness apparatus further comprises an electrode plate and electro-rheological fluid.

11. A vehicle mount apparatus having asymmetrical variable stiffness, comprising:
an engine mount including a fluid wherein a stiffness of said fluid can be adjusted.

12. The apparatus of claim 11, wherein said engine mount further comprises an electromagnet and said fluid is a magneto-rheological fluid.

13. The apparatus of claim 11, wherein said engine mount further comprises an electrode plate and said fluid is an electro-rheological fluid.

14. The apparatus of claim 11, further comprising:
a sensor for detecting a change of speed of a vehicle component; and
a controller configured to receive output from said sensor and adjust the stiffness of the engine mount accordingly.

15. The apparatus of claim 11, wherein said engine mount is a transmission mount.
